(19) United States
(12) Patent Application Publication
(10) Pub. No.: US 2026/0159067 A1
(43) Pub. Date: Jun. 11, 2026

(54) CONTROL DEVICE OF HYBRID ELECTRIC VEHICLE AND CONTROL METHOD OF HYBRID ELECTRIC VEHICLE

(71) Applicant: TOYOTA JIDOSHA KABUSHIKI KAISHA, Toyota-shi (JP)

(72) Inventors: Yoshikazu ASAMI, Gotemba-shi (JP); Yuki Morita, Toyota-shi (JP); Takamitsu Mizutani, Toyota-shi (JP); Nobuo Yagihashi, Miyoshi-shi (JP)

(73) Assignee: TOYOTA JIDOSHA KABUSHIKI KAISHA, Toyota-shi (JP)

(21) Appl. No.: 19/327,444

(22) Filed: Sep. 12, 2025

(30) Foreign Application Priority Data
Dec. 9, 2024 (JP) 2024-214472

(51) Int. Cl. B60W 20/15

(52) U.S. Cl. CPC B60W 20/15; B60W 2510/068; B60W 2530/12; B60W 2710/0677

(57) ABSTRACT

The hybrid electric vehicle includes an engine, a motor, and a filter that collects particulate matter emitted from the engine. The control device controls an output of the engine and an output of the motor according to power needed for the hybrid electric vehicle to travel. The control device is configured to restrict, after the engine starts operating and while pores of the filter are blocked by the condensed water, an output of the engine.

### CROSS-REFERENCE TO RELATED APPLICATION

This application claims priority to Japanese Patent Application No. 2024-214472 filed on Dec. 9, 2024. The disclosure of the above-identified application, including the specification, drawings, and claims, is incorporated by reference herein in its entirety.

### BACKGROUND

### 1. Technical Field

The present disclosure relates to a control device of a hybrid electric vehicle and a control method of a hybrid electric vehicle.

### 2. Description of Related Art

In an engine that has undergone a so-called cold start, the emission amount of particulate matter (PM) increases while the temperature remains low.

Japanese Unexamined Patent Application Publication No. 2021-75074 (JP 2021-75074 A) discloses a control device of a hybrid electric vehicle. The control device suppresses an output of the engine for a certain period of time from a start of operation of the engine. The control device compensates for a shortfall in power needed for traveling by using a motor provided in the hybrid electric vehicle, during the restriction of the output of the engine.

### SUMMARY

An exhaust pipe of the engine is provided with a filter that collects PM. After the engine is cold-started, the condensed water generated by condensing the moisture contained in exhaust gas may block pores of the filter. In this case, among the pores provided in the filter, the amount of the exhaust gas passing through the pores of the filter that are not blocked by the condensed water increases. Therefore, the PM collection efficiency by the filter decreases.

A control device of a hybrid electric vehicle in order to solve the problem described above is applied to the hybrid electric vehicle including an engine, a motor, and a filter configured to collect particulate matter emitted from the engine.

The control device of the hybrid electric vehicle is configured to control an output of the engine and an output of the motor according to power needed for the hybrid electric vehicle to travel.

The control device of the hybrid electric vehicle is configured to restrict, after the engine starts operating and while a pore of the filter is blocked by condensed water, the output of the engine.

A control method of a hybrid electric vehicle that solves the problem described above uses a control device of a hybrid electric vehicle. The control device is applied to the hybrid electric vehicle including an engine, a motor, and a filter configured to collect particulate matter emitted from the engine. The control device is configured to control an output of the engine and an output of the motor according to power needed for the hybrid electric vehicle to travel. The control method of the hybrid electric vehicle includes controlling the engine such that, after the engine starts operating and while a pore of the filter is blocked by condensed water, the output of the engine is equal to or less than a first upper limit value.

The control method of the hybrid electric vehicle includes controlling the engine such that, after blockage of the pore of the filter by the condensed water has been eliminated and until warm-up of the engine is complete, the output of the engine is equal to or less than a second upper limit value that is greater than the first upper limit value.

The control device of the hybrid electric vehicle and the control method of the hybrid electric vehicle can suppress the emission of PM to the outside of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration of a hybrid electric vehicle including a control device of a hybrid electric vehicle according to an embodiment;

FIG. 2 is a flowchart showing a flow of a series of processes executed by the control device of FIG. 1;

FIG. 3 is a time chart showing (a) the output of the engine controlled by the control device of FIG. 1 and (b) the transition of the temperature of the filter; and

FIG. 4 is a flowchart showing a flow of a series of processes executed by the control device according to the Modification.

### DETAILED DESCRIPTION OF EMBODIMENTS

### Configuration of Hybrid Electric Vehicle 100

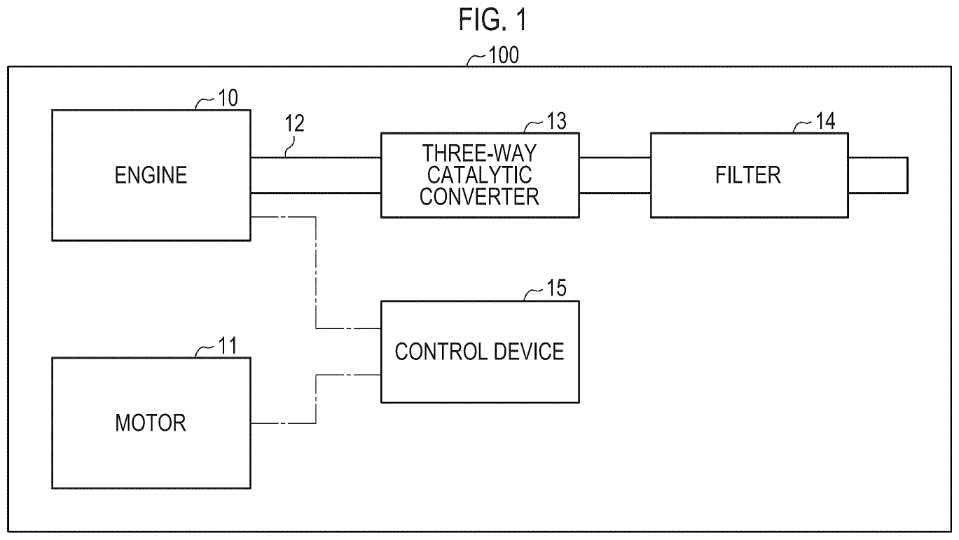

Hereinafter, an embodiment of a control device of a hybrid electric vehicle will be described with reference to FIGS. 1 to 3.

As shown in FIG. 1, the hybrid electric vehicle 100 includes an engine 10. The exhaust pipe 12 is connected to the engine 10. The exhaust gas from the engine 10 is discharged to the outside of the hybrid electric vehicle 100 through the inside of the exhaust pipe 12.

As shown in FIG. 1, a three-way catalytic converter 13 is disposed in the middle of the exhaust pipe 12. The three-way catalytic converter 13 uses a three-way catalyst to remove components such as hydrocarbons contained in the exhaust gas.

As shown in FIG. 1, a filter 14 is disposed downstream of a three-way catalytic converter 13 in an exhaust pipe 12. The filter 14 collects particulate matter (PM) contained in the exhaust gas. A three-way catalyst is supported on the filter 14. Therefore, the filter 14 can also remove components such as hydrocarbons contained in the exhaust gas in the same manner as the three-way catalytic converter 13.

As described above, the exhaust gas of the engine 10 is discharged to the outside of the hybrid electric vehicle 100 after passing through the three-way catalytic converter 13 and the filter 14.

As shown in FIG. 1, the hybrid electric vehicle 100 includes a motor 11. The motor 11 outputs the driving force of the hybrid electric vehicle 100.

As shown in FIG. 1, the hybrid electric vehicle 100 includes a control device 15. The control device 15 is a control device of the hybrid electric vehicle 100. The control device 15 is communicably connected to the engine 10 and the motor 11. The control device 15 controls an output of the engine 10 and an output of the motor 11 according to power needed for the hybrid electric vehicle 100 to travel.

The control device 15 is capable of changing a ratio of a load for outputting power needed for the hybrid electric vehicle 100 to travel by the engine 10 and the motor 11. For example, the control device 15 may request approximately the same level of output from the engine 10 and the motor 11. For example, the control device 15 may request a greater output from the engine 10 than from the motor 11. For example, the control device 15 may request a greater output from the motor 11 than from the engine 10.

### Flow of Series of Processes Executed by Control Device 15

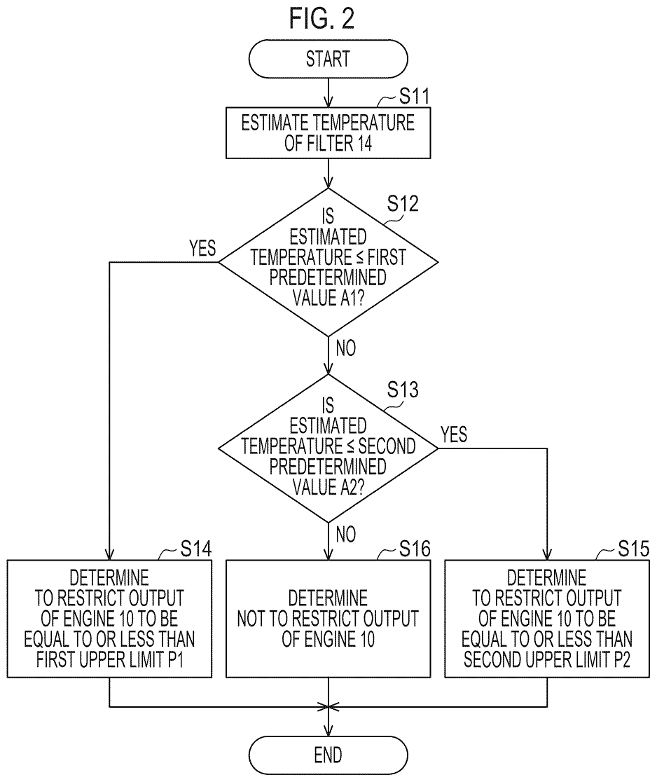

FIG. 2 shows a flow of a series of processes executed by the control device 15. The control device 15 executes a series of processes shown in FIG. 2 at certain time intervals after the engine 10 is started.

In the series of processes shown in FIG. 2, the control device 15 first executes the process of S11. In the process of S11, the control device 15 estimates the temperature of the filter 14. At this time, the control device 15 estimates the temperature of the filter 14 based on the temperature of the coolant in the engine 10 immediately after startup and the integrated value of the amount of intake air in the hybrid electric vehicle 100.

The control device 15 stores a map indicating the temperature of the filter 14 corresponding to a combination of the temperature of the coolant at startup of the engine 10 and the integrated value of the amount of intake air in the hybrid electric vehicle 100. The control device 15 acquires information indicating the amount of intake air from an air flow meter provided in the hybrid electric vehicle 100. The control device 15 acquires information indicating the temperature of the coolant of the engine 10 from a sensor that measures the temperature of the coolant of the engine 10. The control device 15 estimates the temperature of the filter 14 based on the value acquired from the air flow meter and the sensor, and the stored map. The control device 15 executes the process of S12 after estimating the temperature of the filter 14.

In the process of S12, the control device 15 determines whether the estimated temperature of the filter 14 output in the process of S11 is equal to or less than the first predetermined value A1. In the process of S12, when the control device 15 determines that the estimated temperature is equal to or less than the first predetermined value A1 (S12: YES), the process proceeds to S14.

The condensed water generated by the condensation of the moisture contained in the exhaust gas may block the pores of the filter 14. In this case, among the pores provided in the filter 14, the amount of exhaust gas passing through the pores that are not blocked by the condensed water increases. Therefore, the PM collection efficiency by the filter 14 decreases.

When the temperature of the filter 14 is high, since the condensed water evaporates, the condensed water does not block the pores of the filter 14. On the other hand, when the temperature of the filter 14 is low, since the condensed water is less likely to evaporate, the condensed water blocks the pores of the filter 14.

The control device 15 determines that the condensed water is blocking the pores of the filter 14 without evaporating when the estimated temperature is equal to or less than the first predetermined value A1. Then, in the process of S14, the control device 15 determines to restrict the output of the engine 10 to be equal to or less than the first upper limit value P1. Thereafter, the control device 15 ends the series of processes shown in FIG. 2.

Hereinafter, the control device 15 controls the engine 10 such that the output of the engine 10 is equal to or less than the first upper limit value P1. In this case, for example, when the output of the engine 10 that is equal to or less than the first upper limit value P1 does not provide sufficient power for the hybrid electric vehicle 100 to travel, the control device 15 compensates for the shortfall in power needed for the hybrid electric vehicle 100 to travel by using the output of the motor 11. The restriction of the output is performed until the control device 15 executes the series of processes shown in FIG. 2 again.

In the process of S12, when the control device 15 determines that the estimated temperature is not equal to or less than the first predetermined value A1 (S12: NO), the process proceeds to S13. That is, when the estimated temperature is greater than the first predetermined value A1, the control device 15 proceeds the process to S13.

In the process of S13, the control device 15 determines whether the estimated temperature of the filter 14 output in the process of S11 is equal to or less than the second predetermined value A2. The second predetermined value A2 is greater than the first predetermined value A1. In the process of S13, when the control device 15 determines that the estimated temperature is equal to or less than the second predetermined value A2 (S13: YES), the process proceeds to S15.

The engine 10 that has been cold-started increases the emission amount of PM until warm-up is complete.

In addition, as described above, while the condensed water is blocking the pores of the filter 14, PM is likely to be emitted to the outside of the vehicle.

The temperature of the engine 10 needed to evaporate the condensed water blocking the pores of the filter 14 is lower than the temperature when the warm-up of the engine 10 is complete. Therefore, even when the temperature of the filter 14 reaches the temperature at which the condensed water is evaporated, the situation in which the engine 10 is more likely to emit PM to the outside of the vehicle than under normal conditions continues while the warm-up of the engine 10 is not yet complete.

When the estimated temperature is equal to or less than the second predetermined value A2, the control device 15 determines that the warm-up of the engine 10 is not yet complete. Then, in the process of S15, the control device 15 determines to restrict the output of the engine 10 to be equal to or less than the second upper limit value P2. Thereafter, the control device 15 ends the series of processes shown in FIG. 2.

Hereinafter, the control device 15 controls the engine 10 such that the output of the engine 10 is equal to or less than the second upper limit value P2. The second upper limit value P2 is greater than the first upper limit value P1. In this case, for example, when the output of the engine 10 that is equal to or less than the second upper limit value P2 does not provide sufficient power for the hybrid electric vehicle 100 to travel, the control device 15 compensates for the shortfall in power needed for the hybrid electric vehicle 100 to travel by using the output of the motor 11. The restriction of the output is performed until the control device 15 executes the series of processes shown in FIG. 2 again.

In the process of S13, when the control device 15 determines that the estimated temperature is not equal to or less than the second predetermined value A2 (S13: NO), the process proceeds to S16. That is, when the estimated temperature is greater than the second predetermined value A2, the control device 15 proceeds the process to S16.

In the process of S16, the control device 15 determines not to restrict the output of the engine 10. Thereafter, the control device 15 ends the series of processes shown in FIG. 2. Hereinafter, the control device 15 controls the engine 10 without restricting the output of the engine 10.

After executing the process of S16, the control device 15 does not execute the series of processes shown in FIG. 2 until the engine 10 is stopped and started to operate again. The control device 15 may adopt an embodiment in which, after executing the process of S16, the control device 15 executes the series of processes shown in FIG. 2 again after a certain period of time has elapsed.

### Example of Transition of Output of Engine 10 and Temperature of Filter 14

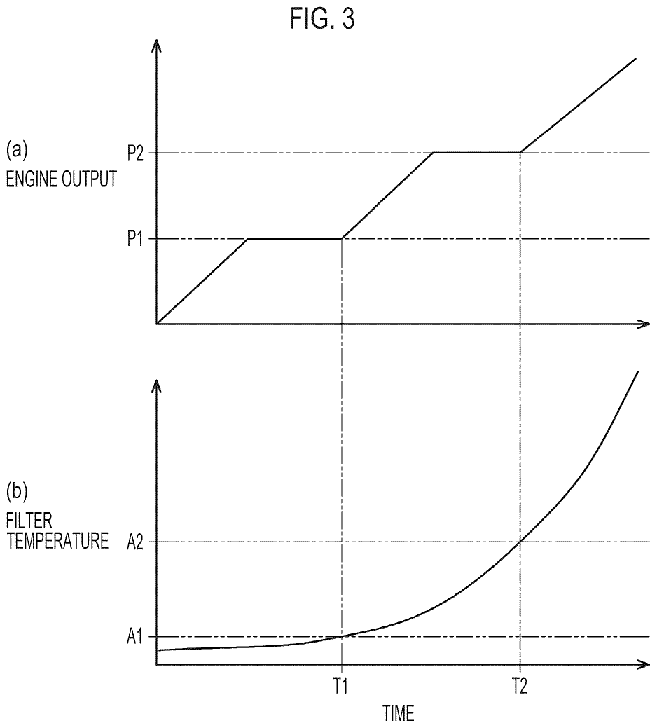

Graph (a) of FIG. 3 shows an example of a transition of an output of the engine 10 when a cold start is performed. In addition, graph (b) of FIG. 3 shows an example of the transition of the temperature of the filter 14 after the engine 10 is cold-started, as estimated by the control device 15.

As shown in graph (b) of FIG. 3, until time T1, the estimated temperature of the filter 14 is equal to or less than the first predetermined value A1. As described above, when the estimated temperature is equal to or less than the first predetermined value A1, the control device 15 determines that the condensed water is blocking the pores of the filter 14. As shown in graph (a) of FIG. 3, until T1, the output of the engine 10 is not greater than a first upper limit value P1.

As the output of the engine 10 is smaller, the emission amount of PM from the engine 10 decreases. The control device 15 controls the engine 10 such that, after the engine 10 starts operating and while the pores of the filter 14 are blocked by the condensed water, the output is equal to or less than the first upper limit value P1. As a result, the control device 15 can suppress the emission of PM to the outside of the vehicle in a situation where the condensed water is blocking the pores of the filter 14.

As shown in graph (b) of FIG. 3, during the period from time T1 to time T2, the estimated temperature of the filter 14 is greater than the first predetermined value A1 and equal to or less than the second predetermined value A2. When the estimated temperature of the filter 14 is greater than the first predetermined value A1, the control device 15 determines that the blockage of the pores of the filter 14 by the condensed water has been eliminated. Further, as described above, when the estimated temperature is equal to or less than the second predetermined value A2, the control device 15 determines that the warm-up of the engine 10 is not yet complete. As shown in graph (a) of FIG. 3, during a period from time T1 to time T2, the output of the engine 10 is not greater than the second upper limit value P2.

The control device 15 controls the engine 10 such that, after the blockage of the pores of the filter 14 by the condensed water has been eliminated and until the warm-up of the engine 10 is complete, the output is equal to or less than the second upper limit value P2. As a result, the control device 15 can suppress the emission of PM to the outside of the vehicle in a situation where the warm-up of the engine 10 is not yet complete.

As shown in graph (b) of FIG. 3, the estimated temperature of the filter 14 is greater than the second predetermined value A2 after time T2. When the estimated temperature of the filter 14 is greater than the second predetermined value A2, the control device 15 determines that the warm-up of the engine 10 is complete. As shown in graph (a) of FIG. 3, the output of the engine 10 is greater than the second upper limit value P2 after time T2.

### Operation of Present Embodiment

The control device 15 reduces the emission amount of PM by the engine 10 by restricting the output of the engine 10 while the pores of the filter 14 are blocked by the condensed water.

### Effects of Embodiment

(1) The control device 15 can suppress the emission of PM to the outside of the vehicle.

(2) The control device 15 controls the engine 10 such that, after the engine 10 starts operating and while the pores of the filter 14 are blocked by the condensed water, the output is equal to or less than the first upper limit value P1. The control device 15 controls the engine 10 such that, after the blockage of the pores of the filter 14 by the condensed water has been eliminated and until the warm-up of the engine 10 is complete, the output is equal to or less than the second upper limit value P2 that is greater than the first upper limit value P1.

The engine 10 that has been cold-started increases the emission amount of PM while the temperature is low.

While some of the pores of the filter 14 are blocked by the condensed water, the collection efficiency of PM by the filter 14 decreases. Therefore, while the condensed water is blocking some of the pores, the amount of PM emitted to the outside of the vehicle is likely to increase compared to when the condensed water is not blocking some of the pores.

The temperature of the engine 10 needed to evaporate the condensed water blocking the pores of the filter 14 is lower than the temperature when the warm-up of the engine 10 is complete.

The control device 15 restricts the output of the engine 10 while sequentially easing the degree of restriction in two stages: a stage from when the engine 10 starts operating until the condensed water in the filter 14 evaporates, and a stage from when the condensed water evaporates until warm-up of the engine 10 is complete. The above stages include a stage from when the engine 10 starts operating until the condensed water in the filter 14 evaporates, and a stage from when the condensed water evaporates until warm-up of the engine 10 is complete. That is, the control device 15 continues to restrict the output of the engine 10 when the temperature of the engine 10 is low and PM is likely to be generated from the engine 10, but changes the degree of restriction according to whether condensed water is present in the filter 14. When the pores of the filter 14 are blocked by the condensed water, and PM is likely to be emitted to the outside of the vehicle, the output of the engine 10 is significantly restricted. On the other hand, when the blockage of the pores by the condensed water has been eliminated, the degree of restriction is eased.

As a result, the control device 15 can suppress unnecessarily restricting the output of the engine 10.

(3) The control device 15 estimates the temperature of the filter 14 based on the amount of intake air in the hybrid electric vehicle 100 and the temperature of the coolant of the engine 10. When the estimated temperature of the filter 14 is equal to or less than a predetermined value, the control device 15 determines that the pores of the filter 14 are blocked by the condensed water.

When the temperature of the filter 14 increases, the condensed water evaporates. The control device 15 restricts the output of the engine 10 while the estimated temperature of the filter 14 is low. The control device 15 can determine that the condensed water is blocking the pores based on the estimated temperature of the filter 14 and restrict the output of the engine 10.

(4) The control method of the hybrid electric vehicle 100 described above uses the control device 15. The control device 15 is applied to a hybrid electric vehicle 100 including an engine 10, a motor 11, and a filter 14 configured to collect particulate matter emitted from the engine 10. The control device 15 controls an output of the engine 10 and an output of the motor 11 according to power needed for the hybrid electric vehicle 100 to travel. The control method of the hybrid electric vehicle 100 includes a step (S14) of controlling, after the engine 10 starts operating and while the pores of the filter 14 are blocked by the condensed water, the engine 10 by the control device 15. In S14, the output of the engine 10 is controlled to be equal to or less than the first upper limit value P1. The control method of the hybrid electric vehicle 100 includes a step (S15) of controlling, by the control device 15, the engine 10 such that, after blockage of the pores of the filter 14 by the condensed water has been eliminated and until warm-up of the engine 10 is complete, the output is equal to or less than a second upper limit value P2 that is greater than the first upper limit value P1. In S15, the output of the engine 10 is controlled to be equal to or less than a second upper limit value P2 that is a value greater than the first upper limit value P1.

The control method of the hybrid electric vehicle 100 restricts the output of the engine 10 while sequentially easing the degree of restriction in two stages. The above stages include a stage from when the engine 10 starts operating until the condensed water in the filter 14 evaporates, and a stage from the evaporation until warm-up of the engine 10 is complete. As a result, the control method of the hybrid electric vehicle 100 can suppress the emission of PM to the outside of the vehicle.

### Modification

The embodiment described above can be modified and carried out as follows. The embodiment described above and the following modification can be carried out in combination within a technically consistent range.

The configuration of the hybrid electric vehicle 100 is not limited to the embodiment shown in FIG. 1. For example, the hybrid electric vehicle 100 may not include the three-way catalytic converter 13.

In the embodiment described above, the control device 15 determines whether the warm-up of the engine 10 is complete based on the estimated temperature of the filter 14. The embodiment in which the control device 15 determines whether the warm-up of the engine 10 is complete is not limited to the embodiment described above. For example, when a certain period of time has elapsed after the engine 10 starts operating, the control device 15 may determine that the warm-up of the engine 10 is complete.

In the embodiment described above, the control device 15 estimates the temperature of the filter 14. Thereafter, the control device 15 determines whether the condensed water is blocking the pores of the filter 14 based on the estimated temperature of the filter 14. The embodiment in which the control device 15 determines whether the condensed water is blocking the pores of the filter 14 is not limited to the embodiment described above.

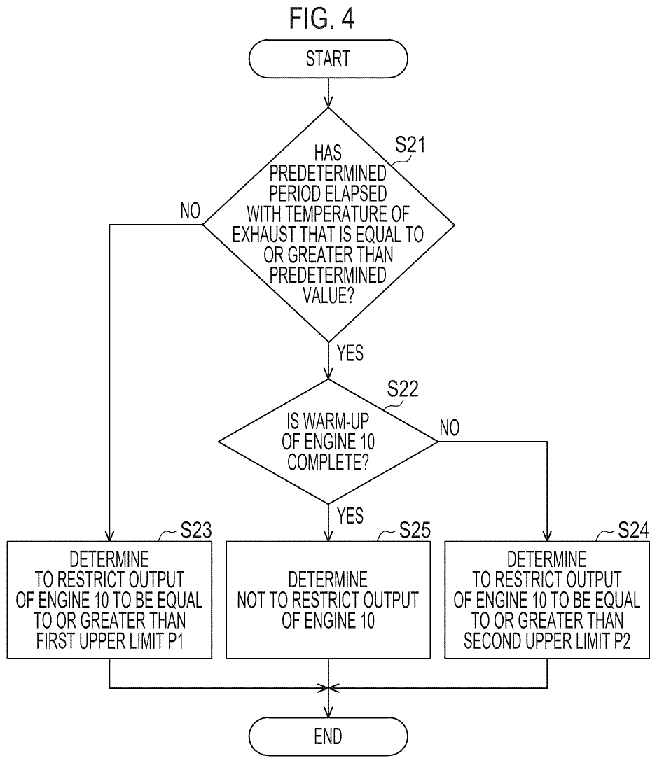

FIG. 4 shows a flow of a series of processes executed by the control device 15 of the Modification. The control device 15 of the Modification executes a series of processes shown in FIG. 4 instead of a series of processes shown in FIG. 2. The control device 15 of the Modification executes a series of processes shown in FIG. 4 at certain time intervals after the engine 10 is started.

In the series of processes shown in FIG. 4, the control device 15 first executes the process of S21. In the process of S21, the control device 15 determines whether a predetermined period has elapsed while the temperature of the exhaust gas of the engine 10 is equal to or greater than a predetermined value.

The temperature of the filter 14 increases due to the exhaust gas passing through the filter 14. Therefore, the control device 15 can determine that the temperature of the filter 14 has increased to a level sufficient to evaporate the condensed water, based on the fact that the exhaust gas at a sufficient temperature has passed through the filter 14 for a sufficient period of time. In other words, the control device 15 can determine that the condensed water is blocking the pores of the filter 14 while the condition described above is not satisfied.

The control device 15 acquires information indicating the temperature of the exhaust gas from a sensor that measures the temperature of the exhaust gas installed in the exhaust pipe 12, for example. The control device 15 determines, based on the information acquired from the sensor, whether a predetermined period has elapsed while the temperature of the exhaust gas of the engine 10 is equal to or greater than a predetermined value.

In the process of S21, when the control device 15 does not determine that the predetermined period has elapsed while the temperature of the exhaust gas of the engine 10 is equal to or greater than the predetermined value (S21: NO), the process proceeds to S23.

The control device 15 determines that the condensed water is blocking the pores of the filter 14 without evaporating from when the engine 10 starts operating until a condition is satisfied in which a predetermined period has elapsed while the temperature of the exhaust gas is equal to or greater than a predetermined value. Then, in the process of S23, the control device 15 determines to restrict the output of the engine 10 to be equal to or less than the first upper limit value P1. Thereafter, the control device 15 ends the series of processes shown in FIG. 4.

Hereinafter, the control device 15 controls the engine 10 such that the output of the engine 10 is equal to or less than the first upper limit value P1. In this case, for example, when the output of the engine 10 that is equal to or less than the first upper limit value P1 does not provide sufficient power for the hybrid electric vehicle 100 to travel, the control device 15 compensates for the shortfall in power needed for the hybrid electric vehicle 100 to travel by using the output of the motor 11. The restriction of the output is performed until the control device 15 executes the series of processes shown in FIG. 4 again.

In the process of S21, when the control device 15 determines that the predetermined period has elapsed while the temperature of the exhaust gas of the engine 10 is equal to or greater than the predetermined value (S21: YES), the process proceeds to S22.

In the process of S22, the control device 15 determines whether the warm-up of the engine 10 is complete. The control device 15 estimates the temperature of the filter 14 in the same manner as the embodiment described in the process of S11 in FIG. 2, for example. Thereafter, when the estimated temperature is greater than the predetermined value, the control device 15 may determine that the warm-up of the engine 10 is complete, in the same manner as the embodiment described in the process of S13 in FIG. 2. For example, when a certain period of time has elapsed after the engine 10 starts operating, the control device 15 may determine that the warm-up of the engine 10 is complete.

In the process of S22, when the control device 15 determines that the warm-up of the engine 10 is not yet complete (S22: NO), the process proceeds to S24. In the process of S24, the control device 15 determines to restrict the output of the engine 10 to be equal to or less than the second upper limit value P2. Thereafter, the control device 15 ends the series of processes shown in FIG. 4.

Hereinafter, the control device 15 controls the engine 10 such that the output of the engine 10 is equal to or less than the second upper limit value P2. In this case, for example, when the output of the engine 10 that is equal to or less than the second upper limit value P2 does not provide sufficient power for the hybrid electric vehicle 100 to travel, the control device 15 compensates for the shortfall in power needed for the hybrid electric vehicle 100 to travel by using the output of the motor 11. The restriction of the output is performed until the control device 15 executes the series of processes shown in FIG. 4 again.

In the process of S22, when the control device 15 determines that the warm-up of the engine 10 is complete (S22: YES), the process proceeds to S25.

In the process of S25, the control device 15 determines not to restrict the output of the engine 10. Thereafter, the control device 15 ends the series of processes shown in FIG. 4. Hereinafter, the control device 15 controls the engine 10 without restricting the output of the engine 10.

After executing the process of S25, the control device 15 does not execute the series of processes shown in FIG. 4 until the engine 10 is stopped and started to operate again. The control device 15 may adopt an embodiment in which, after executing the process of S25, the control device 15 executes the series of processes shown in FIG. 4 again after a certain period of time has elapsed.

In this case, the control device 15 determines that the pores of the filter 14 are blocked by the condensed water from when the engine 10 starts operating until a condition is satisfied in which a predetermined period has elapsed while the temperature of the exhaust gas of the engine 10 is equal to or greater than the predetermined value.

When the high-temperature exhaust gas passes through the filter 14 for a certain period of time or longer, the condensed water that is blocking the pores of the filter 14 evaporates. The control device 15 restricts the output of the engine 10 from when the engine 10 starts operating until the control device 15 determines that the condensed water has evaporated due to the passage of the exhaust gas. As a result, the control device 15 can determine that the condensed water is blocking the pores and restrict the output of the engine 10.

The control device 15 can also determine whether the condensed water is blocking the pores of the filter 14 by observing the pressure difference of the exhaust gas in front of and behind the filter 14. When the condensed water is blocking the filter 14, a pressure difference of the exhaust gas in front of and behind the filter 14 increases. For example, there is a condition that, from when the engine 10 starts operating, a predetermined period has elapsed with a pressure difference of the exhaust gas in front of and behind the filter 14 that is equal to or less than a predetermined value. Until the condition is satisfied, the control device 15 may determine that the condensed water is blocking the pores of the filter 14.

The control device 15 controls the engine 10 such that, after the blockage of the pores of the filter 14 by the condensed water has been eliminated and until the warm-up of the engine 10 is complete, the output is equal to or less than the second upper limit value P2. The control device 15 may control the engine 10 without restricting the output even in a state in which the warm-up of the engine 10 is not yet complete after the blockage of the pores of the filter 14 by the condensed water has been eliminated.

What is claimed is

1. A control device of a hybrid electric vehicle, the control device being applied to the hybrid electric vehicle including an engine, a motor, a filter configured to collect particulate matter emitted from the engine, and being configured to control an output of the engine and an output of the motor according to power needed for the hybrid electric vehicle to travel, wherein the control device is configured to restrict, after the engine starts operating and while a pore of the filter is blocked by condensed water, the output of the engine.

2. The control device according to claim 1, wherein the control device is configured to
control the engine such that, after the engine starts operating and while the pore of the filter is blocked by the condensed water, the output of the engine is equal to or less than a first upper limit value, and
control the engine such that, after blockage of the pore of the filter by the condensed water has been eliminated and until warm-up of the engine is complete, the output of the engine is equal to or less than a second upper limit value that is greater than the first upper limit value.

3. The control device according to claim 1, wherein the control device is configured to
estimate a temperature of the filter based on an intake air amount in the hybrid electric vehicle and a temperature of a coolant of the engine, and
determine that the pore of the filter is blocked by the condensed water when the temperature of the filter that is estimated is equal to or less than a predetermined value.

4. The control device according to claim 1, wherein the control device is configured to determine that the pore of the filter is blocked by the condensed water from when the engine starts operating until a condition that a predetermined period has elapsed in a state in which a temperature of exhaust gas of the engine is equal to or greater than a predetermined value is satisfied.

5. A control method of a hybrid electric vehicle that uses a control device of the hybrid electric vehicle, the control device being applied to the hybrid electric vehicle including an engine, a motor, and a filter configured to collect particulate matter emitted from the engine, and being configured to control an output of the engine and an output of the motor according to power needed for the hybrid electric vehicle to travel, the control method comprising:
controlling the engine such that, after the engine starts operating and while a pore of the filter is blocked by condensed water, the output of the engine is equal to or less than a first upper limit value; and
controlling the engine such that, after blockage of the pore of the filter by the condensed water has been eliminated and until warm-up of the engine is complete, the output of the engine is equal to or less than a second upper limit value that is greater than the first upper limit value.
